(19) United States
(12) Patent Application Publication
(10) Pub. No.: US 2025/0259452 A1
(43) Pub. Date: Aug. 14, 2025

(54) ROADSIDE DEVICE

(71) Applicant: TOYOTA JIDOSHA KABUSHIKI KAISHA, Toyota-shi (JP)

(72) Inventors: Toshiki KASHIWAKURA, Tokyo (JP); Chihiro INABA, Tokyo (JP); Tsuyoshi OKADA, Nagoya-shi (JP); Yasuhiro KOBATAKE, Nagoya-shi (JP); Shoi SUZUKI, Tokyo (JP)

(73) Assignee: TOYOTA JIDOSHA KABUSHIKI KAISHA, Toyota-shi (JP)

(21) Appl. No.: 18/960,475

(22) Filed: Nov. 26, 2024

(30) Foreign Application Priority Data
Feb. 9, 2024 (JP) 2024-018922

(51) Int. Cl. G06V 20/54; G06V 20/40; H04W 4/40; H04W 68/00

(52) U.S. Cl. CPC G06V 20/54; G06V 20/40; H04W 4/40; H04W 68/00; G06V 2201/08

(57) ABSTRACT

A roadside device including an imaging unit, a communication unit, a notification unit, and a control unit, wherein when a pedestrian near a road is detected from a video from the imaging unit, the control unit receives vehicle information including relative position information between a first vehicle that is an autonomous driving vehicle approaching the roadside device and a second vehicle around the first vehicle from an information processing device via the communication unit, and notifies the pedestrian of notification information including the relative position information by the notification unit.

### CROSS-REFERENCE TO RELATED APPLICATION

This application claims priority to Japanese Patent Application No. 2024-018922 filed on Feb. 9, 2024, incorporated herein by reference in its entirety.

### BACKGROUND

### 1. Technical Field

The present disclosure relates to roadside devices.

### 2. Description of Related Art

Conventionally, there has been known a technique related to roadside devices that notify people to be notified such as pedestrians and drivers and assistant drivers of vehicles of the presence of a vehicle or a pedestrian. For example, Japanese Unexamined Patent Application Publication No. 2023-50629 (JP 2023-50629 A) discloses a notification system. This notification system notifies pedestrians or vehicles other than an autonomous vehicle that is going to pass through a predetermined traffic area of whether the pedestrians or the vehicles can proceed, or alerts the pedestrians or the vehicles, according to the behavior of the autonomous vehicle.

### SUMMARY

The operation of an autonomous vehicle cannot be predicted from the behavior (gesture, eye contact, etc.) of its driver or assistant driver. It is therefore desirable from the safety point of view to notify pedestrians of the presence of an autonomous vehicle. However, it is sometimes difficult for pedestrians to determine whether the vehicle is being autonomously driven by merely looking at the vehicle from the outside. Therefore, when a plurality of vehicles including an autonomous vehicle approaches a pedestrian, the pedestrian may not be able to determine which vehicle is an autonomous vehicle if the pedestrian is only notified that an autonomous vehicle is approaching.

In view of such circumstances, an object of the present disclosure is to improve the technique related to roadside devices.

A roadside device according to an embodiment of the present disclosure includes: an imaging unit; a communication unit; a notification unit; and a control unit. The control unit is configured to when a pedestrian near a road is detected from a video from the imaging unit, receive vehicle information from an information processing device via the communication unit, the vehicle information including relative position information between a first vehicle that is an autonomous vehicle approaching the roadside device and a second vehicle located around the first vehicle, and cause the notification unit to notify the pedestrian of notification information including the relative position information.

According to the embodiment of the present disclosure, the technique related to roadside devices is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a block diagram illustrating a schematic configuration of a first vehicle that is an autonomous vehicle;

FIG. 3 is a block diagram illustrating a schematic configuration of a roadside device;

FIG. 4 is a block diagram illustrating a schematic configuration of an information processing device;

FIG. 5 is a flow chart illustrating the operation of the roadside device; and

FIG. 6 is an example of an image displayed on a display of a roadside device.

### DETAILED DESCRIPTION OF EMBODIMENTS

Hereinafter, an embodiment of the present disclosure will be described.

### Outline of Embodiment

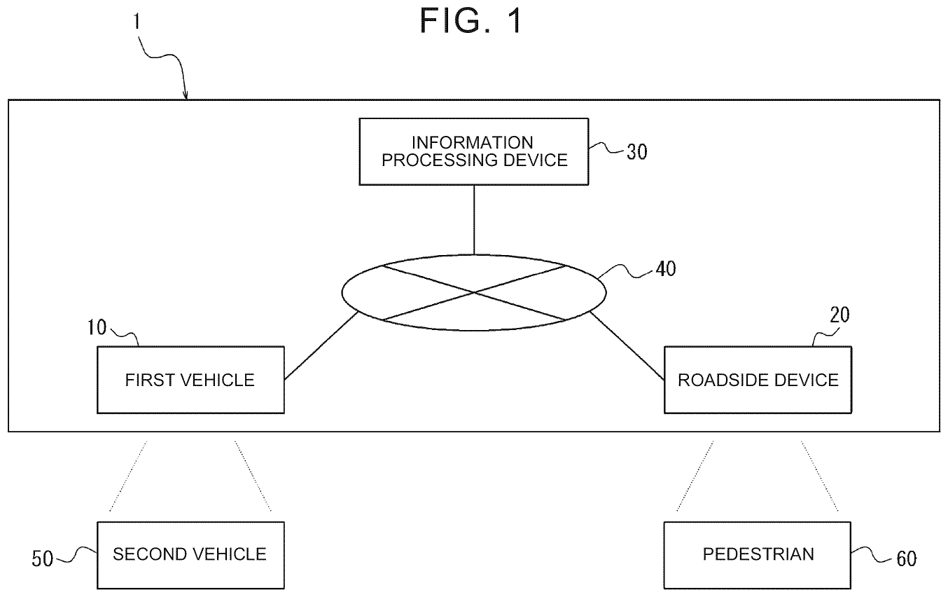

The outline of a system 1 according to an embodiment of the present disclosure will be described with reference to FIG. 1. The system 1 includes a first vehicle 10, a roadside device 20, and an information processing device 30. The first vehicle 10, the roadside device 20, and the information processing device 30 are communicably connected to a network 40 including, for example, the Internet and a mobile communication network.

The first vehicle 10 is a connected car having a communication function with the network 40. The driving of the vehicle 10 is automated at any level. The level of automation may be, for example, any of level 1 to level 5 in the level division of society of automotive engineers (SAE). The first vehicle 10 may be driven by a driver. The first vehicle 10 is, for example, a vehicle such as a battery electric vehicle (BEV), a hybrid electric vehicle (HEV), a plug-in hybrid electric vehicle (PHEV), or a fuel cell electric vehicle (FCEV), but is not limited thereto, and may be any vehicle capable of being ridden by a human. The system 1 may comprise one or more first vehicles 10.

The first vehicle 10 includes a camera for detecting a second vehicle 50 around the first vehicle 10. In the present embodiment, since the second vehicle 50 does not have a communication function with the network 40, the first vehicle 10 needs to detect the second vehicle 50 in order to acquire the information on the second vehicle 50.

The roadside device 20 is installed at a position where the pedestrian 60 can be detected from the video from the mounted camera, for example, near the boundary between the road and the sidewalk. The roadside device 20 includes a notification unit 23 for notifying the pedestrian 60 of vehicle information. The notification unit 23 includes, for example, a display and/or a speaker.

The information processing device 30 is one or more computers such as a server device. In the present embodiment, communication between the first vehicle 10 and the roadside device 20 is performed via the information processing device 30. For example, the information of the first vehicle 10 and the information of the second vehicle 50 detected by the first vehicle 10 are transmitted to the roadside device 20 via the information processing device 30. The information processing device 30 may communicate with the first vehicle 10 and continuously receive information of the first vehicle 10.

First, the outline of the present embodiment will be described, and the details will be described later. The roadside device 20 includes an imaging unit 21, a communication unit 22, a notification unit 23, and a control unit 25. The roadside device 20 receives vehicle information from the information processing device 30 via the communication unit 22 when the pedestrian 60 near the road is detected from the video from the imaging unit 21. The vehicle information includes relative position information of the first vehicle 10, which is an autonomous vehicle approaching the roadside device 20, and the second vehicle 50 around the first vehicle 10. The roadside device 20 notifies the pedestrian 60 of the notification information including the relative position information by the notification unit 23.

According to the present embodiment, the pedestrian 60 can grasp the relative position between the autonomous vehicle and another vehicle around the autonomous vehicle. Accordingly, the pedestrian 60 can identify the autonomous vehicle from among the plurality of vehicles. Therefore, the safety of the pedestrian 60 is improved.

Further, according to the present embodiment, the roadside device 20 can notify the pedestrian 60 of the presence of the vehicle located at the blind spot of the roadside device 20 generated by the plurality of vehicles. For example, when an autonomous vehicle is located behind a large vehicle such as a truck or in front of a small vehicle such as a motorcycle, the roadside device 20 can notify the pedestrian 60 of information on the autonomous vehicle and information on the vehicle around the autonomous vehicle. Accordingly, the pedestrian 60 can grasp the vehicle located at the blind spot, and thus the safety of the pedestrian 60 is improved.

As described above, the present embodiment improves the technology related to the roadside device 20.

Next, each configuration of the system I will be described in detail.

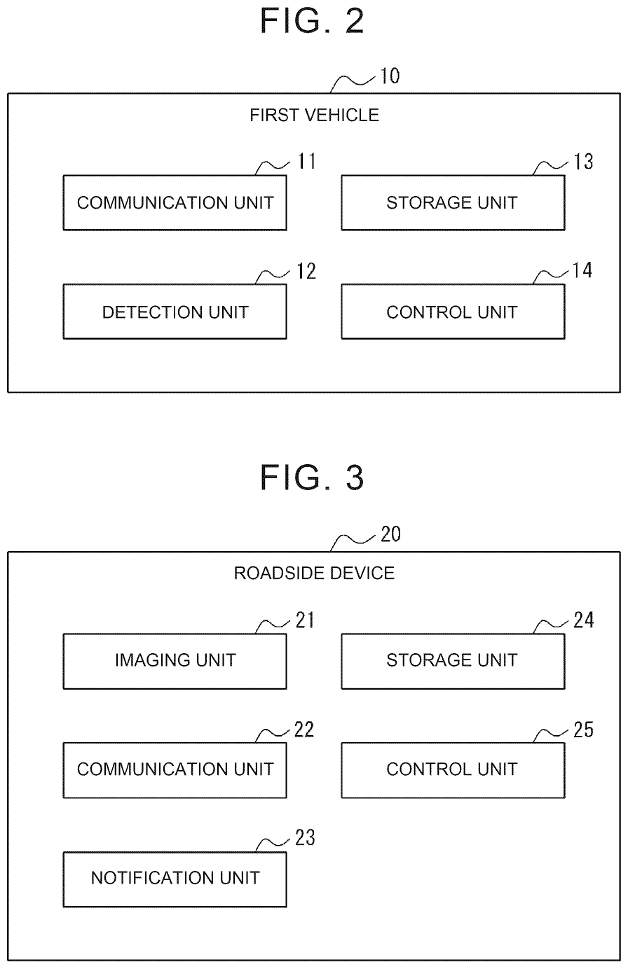

As illustrated in FIG. 2, the first vehicle 10 includes a communication unit 11, a detection unit 12, a storage unit 13, and a control unit 14.

The communication unit 11 includes one or more communication interfaces connected to the network 40. This communication interface corresponds to a mobile communication standard such as 4th generation (4G) or 5th generation (5G), for example, but is not limited thereto. The communication unit 11 may include an inter-vehicle interface for communicating with the second vehicle 50 around the first vehicle 10.

The detection unit 12 includes one or more cameras capable of detecting one or more second vehicles 50 around the first vehicle 10. The detection unit 12 may include, for example, two or more cameras arranged at positions capable of capturing an image of the periphery of the first vehicle 10, or an omnidirectional camera capable of capturing an image of the periphery of the first vehicle 10. The detection unit 12 may further include a device for measuring the inter-vehicle distance, for example, a millimeter-wave radar or a LiDAR. The detection unit 12 may detect the second vehicle 50 by inter-vehicle communication using the inter-vehicle interface of the communication unit 11.

The storage unit 13 includes one or more memories. The memories are, for example, a semiconductor memory, a magnetic memory, or an optical memory, but are not limited to these memories. Each memory included in the storage unit 13 may function as, for example, a main storage device, an auxiliary storage device, or a cache memory. The storage unit 13 stores arbitrary information used for the operation of the first vehicle 10. For example, the storage unit 13 may store a system program, an application program, embedded software, and information of the first vehicle 10. The information stored in the storage unit 13 may be updatable by, for example, information received from the network 40 via the communication unit 11.

The control unit 14 includes one or more processors, one or more programmable circuits, one or more dedicated circuits, or a combination thereof. The processors are, for example, a general-purpose processor such as a central processing unit (CPU) or a graphics processing unit (GPU), or a dedicated processor specialized for a specific process, but are not limited to these processors. The programmable circuits are, for example, a field-programmable gate array (FPGA), but are not limited to the circuit. The dedicated circuits are, for example, an application specific integrated circuit (ASIC), but are not limited to the circuit. The control unit 14 controls the overall operation of the first vehicle 10.

### Configuration of the Roadside Device 20

As illustrated in FIG. 3, the roadside device 20 includes an imaging unit 21, a communication unit 22, a notification unit 23, a storage unit 24, and a control unit 25. The roadside device 20 is installed at a position where the pedestrian 60 can be detected from the video from the mounted imaging unit 21, for example, near the boundary between the road and the sidewalk. The roadside device 20 may be installed near a crosswalk, near an intersection, or the like. The roadside device 20 may or may not be fixed to a road or sidewalk.

The imaging unit 21 includes one or more cameras for photographing the pedestrian 60. The camera may capture an image of the first vehicle 10 or the second vehicle 50. For example, the imaging unit 21 may include two 90-degree cameras, two 180-degree cameras, or one 360-degree camera.

The communication unit 22 includes one or more communication interfaces connected to the network 40. The communication interfaces correspond to, but are not limited to, a mobile communication standard such as 4th generation (4G) or 5th generation (5G), a wired LAN standard, or a radio LAN standard.

The notification unit 23 includes one or more notification devices for notifying the pedestrian 60 near the roadside device 20 of information. The notification device may include a display and/or a speaker. The notification unit 23 may further include a notification device for directly notifying the driver or assistant driver of the first vehicle 10 of the information of the pedestrian 60, for example, an electric bulletin board or a blinking light.

The storage unit 24 includes one or more memories. Each memory included in the storage unit 24 may function as, for example, a main storage device, an auxiliary storage device, or a cache memory. The storage unit 24 stores arbitrary information used for the operation of the roadside device 20. For example, the storage unit 24 may store a system program, an application program, embedded software, and the like. The information stored in the storage unit 24 may be updatable by, for example, information acquired from the network 40 via the communication unit 22.

The control unit 25 includes one or more processors, one or more programmable circuits, one or more dedicated circuits, or a combination of these. The control unit 25 controls the operation of the roadside device 20.

### Configuration of the Information Processing Device 30

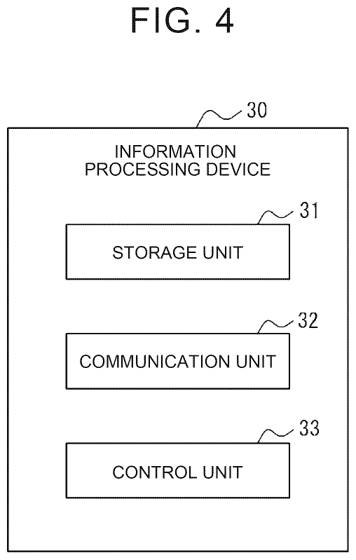

As illustrated in FIG. 4, the information processing device 30 includes a storage unit 31, a communication unit 32, and a control unit 33.

The storage unit 31 includes one or more memories. Each of the memories included in the storage unit 31 may function as a main storage device, auxiliary storage device, or cache memory, for example. The storage unit 31 stores arbitrary information used for the operation of the information processing device 30. For example, the storage unit 31 may store a system program, an application program, embedded software, a position of the roadside device 20, map information, and the like. The information stored in the storage unit 31 may be updatable by, for example, information received from the network 40 via the communication unit 32.

The communication unit 32 includes one or more communication interfaces connected to the network 40. This communication interface corresponds to a mobile communication standard such as 4th generation (4G) or 5th generation (5G), for example, but is not limited thereto. In the present embodiment, the information processing device 30 communicates with the vehicle 10 and the roadside device 20 via the communication unit 32 and the network 40.

The control unit 33 includes one or more processors, one or more programmable circuits, one or more dedicated circuits, or a combination of these. The control unit 33 controls the overall operation of the information processing device 30.

### Operation Flow of the Roadside Device 20

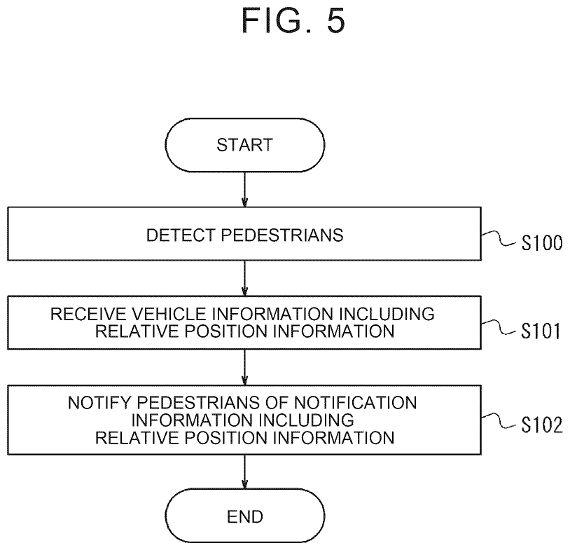

The operation of the roadside device 20 according to the present embodiment will be described with reference to FIG. 5.

S100: The control unit 25 of the roadside device 20 detects the pedestrian 60 near the road from the video from the imaging unit 21.

The control unit 25 detects the pedestrian 60 in the video by an arbitrary object recognition process. The control unit 25 may specify that the pedestrian 60 is moving and the moving direction of the pedestrian 60 from the change in the position of the pedestrian 60 in the video. The control unit 25 may identify the pedestrian 60 moving toward the road as a “pedestrian near the road”.

S101: The control unit 25 receives, from the information processing device 30 via the communication unit 22, vehicle information including relative position information between the first vehicle 10 that is an autonomous vehicle approaching the roadside device 20 and the second vehicle 50 located around the first vehicle 10.

Specifically, first, the control unit 25 of the roadside device 20 transmits a request for acquiring vehicle information to the information processing device 30 via the communication unit 22. The control unit 33 of the information processing device 30 transmits the acquisition request to the first vehicle 10 via the communication unit 32. The control unit 14 of the first vehicle 10 detects the second vehicle 50 by the detection unit 12 in response to the acquisition request. In the present embodiment, since the second vehicle 50 does not have a communication function with the network 40, it is necessary to detect the second vehicle 50 by the first vehicle 10. The control unit 14 of the first vehicle 10 may detect two or more second vehicles 50 by the detection unit 12. The second vehicle 50 may travel or stop. Furthermore, the control unit 14 transmits the information of the first vehicle 10 and the detected information of the second vehicle 50 to the information processing device 30 via the communication unit 11. The control unit 33 calculates relative position information based on information (for example, positions) of the first vehicle 10 and the second vehicle 50. The control unit 33 further transmits vehicle information including the relative position information to the roadside device 20 via the communication unit 32.

The relative position information may include any information regarding the relative positional relationship between the first vehicle 10 and the second vehicle 50. For example, the relative position information may include information indicating the number of the first vehicles and the second vehicles, information identifying that the first vehicle 10 is an autonomous vehicle, and information indicating the position of the first vehicle 10 with respect to the second vehicle 50 when viewed from the roadside device 20. The relative position information may include information indicating a positional relationship (front-rear, left-right diagonal direction) or a distance between the first vehicle 10 and the second vehicle 50. For example, the relative position information may include information indicating that the autonomous vehicle (first vehicle 10) is traveling behind the truck or the like (second vehicle 50). Alternatively, the relative position information may include information indicating that the autonomous vehicle (the first vehicle 10) approaches from the side of the vehicle train (the plurality of second vehicles 50) that is stopped. The relative position information is not limited to the above-described example, and may include information such as a size, a type, a position on a road, a distance from the roadside device 20, and a speed (for example, a legal speed or an excess of a speed limit), of the first vehicle 10 and the second vehicle 50. The relative position information may include information indicating that the first vehicle 10 or the second vehicle 50 is about to turn right and left, is about to be suddenly braked, is about to exit the congested train, or is about to overtake the vehicle. The vehicle information is not limited to the relative position information, and may include any information regarding the first vehicle 10 and the second vehicle 50.

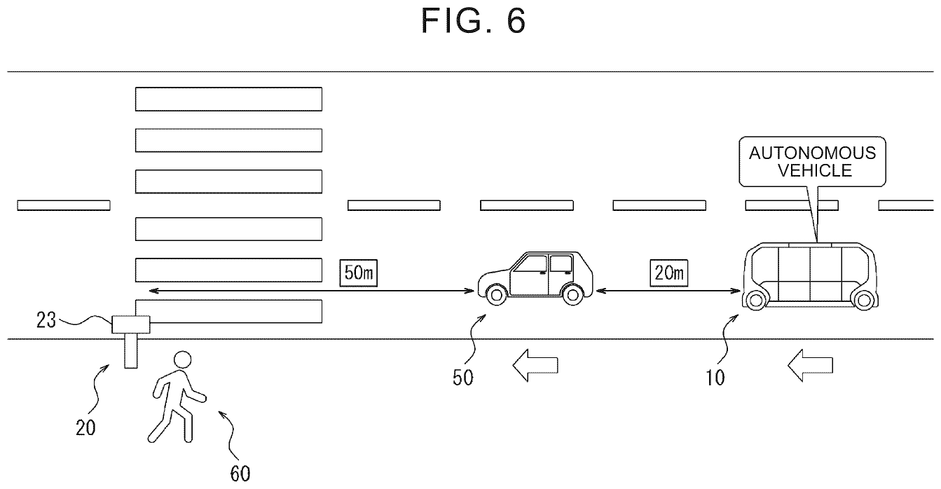

The relative position information may include an image displayed on the display of the roadside device 20 and/or a message output by a speaker of the roadside device 20. FIG. 6 is an example of an image displayed on a display. The image shows the first vehicle 10, the roadside device 20, the second vehicle 50, and the pedestrian 60 on a schematic map. The roadside device 20 is disposed near the crosswalk. The pedestrian 60 is located near the roadside device 20. The first vehicle 10 and the second vehicle 50 travel on the roadside and approach the roadside device 20 and the pedestrian 60. The image indicates that the first vehicle is traveling behind the second vehicle 50. The images are textually displaying information identifying that the first vehicle 10 is an autonomous vehicle, a distance between the roadside device 20 and the second vehicle (“50 m” in FIG. 6), and a distance between the second vehicle and the first vehicle 10 (“20 m” in FIG. 6). The image may use color coding, arrows, flashing, etc. to emphasize that the first vehicle is an autonomous vehicle. By viewing the image, the pedestrian 60 can understand the number of the first vehicle 10 and the second vehicle 50, the order of the first vehicle 10 with respect to the second vehicle 50 when viewed from the roadside device 20, and the positional relationship between the first vehicle 10 and the second vehicle 50. The messages output by the speaker are messages such as “Two vehicles are approaching from the right. The second vehicle from the head is an autonomous vehicle. ”, “The vehicle is approaching from 50 meters to the right. The autonomous vehicle comes closer to 25 meters behind the head vehicle.”

S102: The control unit 25 notifies the pedestrian 60 of notification information including the relative position information by the notification unit 23.

The relative position information is notified to the pedestrian 60 by, for example, an image displayed on the display of the roadside device 20 or a sound output by a speaker of the roadside device 20. The notification information may further include vehicle information other than the relative position information, crossing availability information indicating whether or not the pedestrian 60 can cross the road, or attention calling information urging the pedestrian 60 to pay attention to the left and right.

As described above, the roadside device 20 according to the present embodiment receives the vehicle information from the information processing device 30 via the communication unit 22 when the pedestrian 60 near the road is detected from the video from the imaging unit 21. The vehicle information includes relative position information of the first vehicle 10, which is an autonomous vehicle approaching the roadside device 20, and the second vehicle 50 around the first vehicle 10. The roadside device 20 notifies the pedestrian 60 of the notification information including the relative position information by the notification unit 23.

With this configuration, the pedestrian 60 can grasp the relative position between the autonomous vehicle approaching the roadside device 20 and another vehicle surrounding the autonomous vehicle. Accordingly, the pedestrian 60 can identify the autonomous vehicle from among the plurality of vehicles. Therefore, the safety of the pedestrian 60 is improved.

According to this configuration, the roadside device 20 can notify the pedestrian 60 of the presence of the vehicle located at the blind spot of the roadside device 20 generated by the plurality of vehicles. For example, even when an autonomous vehicle is located behind a large vehicle such as a truck or in front of a small vehicle such as a motorcycle, the roadside device 20 can notify the pedestrian 60 of information on the autonomous vehicle and information on the vehicle detected by the autonomous vehicle. Accordingly, the pedestrian 60 can grasp the vehicle located at the blind spot, and thus the safety of the pedestrian 60 is improved.

Although the present disclosure has been described with reference to the drawings and examples, it should be noted that various changes and modifications may be made by those skilled in the art based on the present disclosure. It should therefore be noted that these variations and modifications are within the scope of the present disclosure. For example, the functions included in the configurations, steps, etc. can be rearranged so as not to be logically inconsistent, and a plurality of configurations, steps, etc. can be combined into one or divided.

The roadside device 20 may receive the vehicle information from the first vehicle 10 without passing through the information processing device 30. In a case where the second vehicle 50 has a communication function with the network 40, the roadside device 20 may receive the information of the first vehicle 10 and the second vehicle 50 from the first vehicle 10 and the second vehicle 50 without passing through or via the information processing device 30, and acquire the vehicle information.

The roadside device 20 may send the pedestrian information on the pedestrian 60 detected from the video from the imaging unit 21 to the first vehicle 10 or a mobile terminal carried by the driver or assistant driver of the first vehicle 10 via the information processing device 30. Thus, the driver or assistant driver of the first vehicle 10 can grasp the behavior of the pedestrian 60 based on the received pedestrian information. The pedestrian information may include information indicating the presence, crossing situation, or pop-out of the pedestrian 60. The mobile terminal may be, for example, a smartphone, a tablet, or a laptop computer. The information processing device 30 may further transmit the stop information recommending the stopping of the traveling to the first vehicle 10 or the mobile terminal carried by the driver or assistant driver of the first vehicle 10. The information processing device 30 may also notify vehicle information. Thus, the driver or assistant driver of the first vehicle 10 can recognize the behavior of the second vehicle 50, for example, the sudden braking applied by the driver of the second vehicle 50 who views the pedestrian 60.

The roadside device 20 may directly notify the driver or assistant driver of the first vehicle 10 of the pedestrian information by using an electric bulletin board or a blinking light mounted on the roadside device 20 so that the driver or assistant driver of the first vehicle 10 can easily perceive the pedestrian 60.

The vehicle information may be corrected by the information processing device 30 based on the information of the first vehicle 10 and the second vehicle 50 detected from the video from the imaging unit 21 of the roadside device 20. For example, two or more second vehicles (for example, large vehicles) may travel between the roadside device 20 and the first vehicle 10, and vehicle information (for example, the number of the first vehicle 10 or the second vehicle 50) acquired from the roadside device 20 and the first vehicle 10 may be inconsistent. In this case, the information processing device 30 may adopt the information of the first vehicle 10 and the information of the second vehicle 50 detected from the video from the imaging unit 21 of the roadside device 20 as the vehicle information. The information processing device 30 may further modify the vehicle information based on information acquired from a monitoring device such as another first vehicle 10, another roadside device 20, or a monitoring camera installed near the road. These monitoring devices may be present in a position in which all the first vehicles 10 and all the second vehicles 50 can be monitored. For example, two or more first vehicles 10 may travel on a plurality of lanes (e.g., oncoming lanes, two lanes on one side). Also, for example, two roadside devices 20 may be installed near both ends of the crosswalk.

What is claimed is:

1. A roadside device comprising: an imaging unit; a communication unit; a notification unit; and a control unit, wherein the control unit is configured to
when a pedestrian near a road is detected from a video from the imaging unit, receive vehicle information from an information processing device via the communication unit, the vehicle information including relative position information between a first vehicle that is an autonomous vehicle approaching the roadside device and a second vehicle located around the first vehicle, and
cause the notification unit to notify the pedestrian of notification information including the relative position information.

2. The roadside device according to claim 1, wherein the relative position information includes information indicating the number of the first vehicles and the second vehicles, information identifying that the first vehicle is an autonomous vehicle, and information indicating a position of the first vehicle with respect to the second vehicle as viewed from the roadside device.

3. The roadside device according to claim 1, wherein:
the second vehicle is detected by a detection unit of the first vehicle; and
the relative position information is calculated by a control unit of the information processing device based on information on the first vehicle and the second vehicle received by the information processing device from the first vehicle.

4. The roadside device according to claim 1, wherein the control unit is further configured to send pedestrian information on the pedestrian detected from the video from the imaging unit to a mobile terminal carried by a driver or an assistant driver of the first vehicle through the information processing device via the communication unit.

5. The roadside device according to claim 1, wherein the vehicle information is corrected by the information processing device based on information on the first vehicle and the second vehicle detected from the video from the imaging unit.
